(19) United States
(12) Patent Application Publication
(10) Pub. No.: US 2012/0132695 A1
(43) Pub. Date: May 31, 2012

(54) WIRE FEEDING APPARATUS FOR WIRE BONDERS

(76) Inventors: Yue ZHANG, Singapore (SG); Xiao Liang CHEN, Singapore (SG); Keng Yew James SONG, Singapore (SG)

(21) Appl. No.: 12/956,068

(22) Filed: Nov. 30, 2010

(51) Int. Cl. B23K 37/04

(52) U.S. Cl. 228/44.3

(57) ABSTRACT

A wire bonder comprises a bonding tool for forming wire bonds and a pneumatic device for feeding wire to the bonding tool. An upper clamp and a lower clamp are aligned along a wire feeding route between the pneumatic device and the bonding tool to clamp the wire at respective clamping points. A fixed intermediate guiding chamber extends substantially from the upper clamp to the lower clamp. The said intermediate guiding chamber encloses the wire along the wire feeding route and is operative to shield and guide the wire.

### FIELD OF THE INVENTION

The invention relates to wire bonders, and in particular to a wire-feeding apparatus and method for feeding and guiding wires in wire bonders.

### BACKGROUND AND PRIOR ART

Wire bonders are used during semiconductor assembly and packaging for making electrical wire connections between electrical contact pads on a die and a substrate, or between electrical contact pads on different dice. Wire is fed from a wire spool containing bonding wire, typically gold or copper wire, to a bonding tool such as a capillary for performing wire bonding at the bonding tool.

Along the feeding route of the wire between the wire spool and the capillary, the wire passes through various devices, which may include a pneumatic device and a wire clamp for controlling feeding of the wire during wire bonding. FIG. 1 is a side view of a conventional wire bonder. Bonding wire 100, for instance gold or copper wire, is fed from a wire spool (not shown) into a pneumatic device 102 which is operative to apply vertical vacuum suction forces upwards or downwards to urge movement of the bonding wire 100 in these directions. A wire guider 104 is located some distance away from the pneumatic device 102 and it has a small hole for threading and guiding the bonding wire 100 along the feeding route. A wire clamp 106 is located below the wire guider 104 to clamp onto the bonding wire 100 when movement of the bonding wire 100 is to be restrained. The bonding wire 100 is then passed through a capillary 108 located at one end of a transducer horn 110. Wire bonding is conducted at a bottom tip of the capillary 108.

A shortcoming of such a conventional wire bonder design is that a relatively long length of wire 100 between the pneumatic device 102 and the wire guider 104 is exposed to turbulent air flow, which causes the wire to bend and form kinks. The wire is also exposed to contaminants in the bonding area. As a result, there is poor wire looping performance which results in defective wire bonds.

FIG. 2 is a side view of a conventional wire bonder including an upper wire clamp 112 and a lower wire clamp 106 illustrating the effects of undesirable disturbances in the air to a wire 100 that is fed through the wire clamps. The wire 100 which is fed through and held between the wire clamps is exposed and therefore subject to turbulent air flow and contamination during wire bonding. Moreover, the wire 100 experiences an acceleration force due to the movement of the wire bonder during wire bonding. If large enough, the acceleration force causes the wire 100 to bend and form kink in the exposed length of wire 100 between the upper and lower wire clamps 112, 106. This may affect wire looping and wire bonds may not be well-formed.

FIG. 3 is a side view of a conventional wire bonder showing a wire that has been fed into the wire bonder deviating from a vertical feeding path during wire bonding. The wire guider 104 is arranged with the wire clamp 106 located between the wire guider 104 and the capillary 108. This gives rise to a large gap between the wire guider 104 and the capillary 108 such that the wire 100 deviates from the vertical feeding path significantly, affecting wire looping and hence the wire bonds formed. It is thus desirable to reduce the deviation of the wire 100 from the vertical feeding path to improve wire bonding performance. It is also desirable to improve wire bonder performance without the undesirable disturbances experienced from using conventional wire bonders which arise from turbulent air flow and contamination as discussed above.

### SUMMARY OF THE INVENTION

It is thus an object of the invention to seek to provide a wire bonding system and method which efficiently feeds wire to a wire bonder, reduces interruption to wire bonding operations and promotes the formation of good quality wire bonds.

Accordingly, the invention provides a wire bonder comprising: a bonding tool for forming wire bonds; a pneumatic device for feeding wire to the bonding tool; an upper clamp and a lower clamp aligned along a wire feeding route between the pneumatic device and the bonding tool to clamp the wire at respective clamping points; and a fixed intermediate guiding chamber extending substantially from the upper clamp to the lower clamp which encloses the wire along the wire feeding route and which is operative to shield and guide the wire.

It would be convenient hereinafter to describe the invention in greater detail by reference to the accompanying drawings which illustrate one embodiment of the invention. The particularity of the drawings and the related description is not to be understood as superseding the generality of the broad identification of the invention as defined by the claims.

### BRIEF DESCRIPTION OF THE DRAWINGS

Examples of the preferred embodiment of a wire bonder in accordance with the invention will now be described with reference to the accompanying drawings, in which:

FIG. 1 is a side view of a conventional wire bonder;

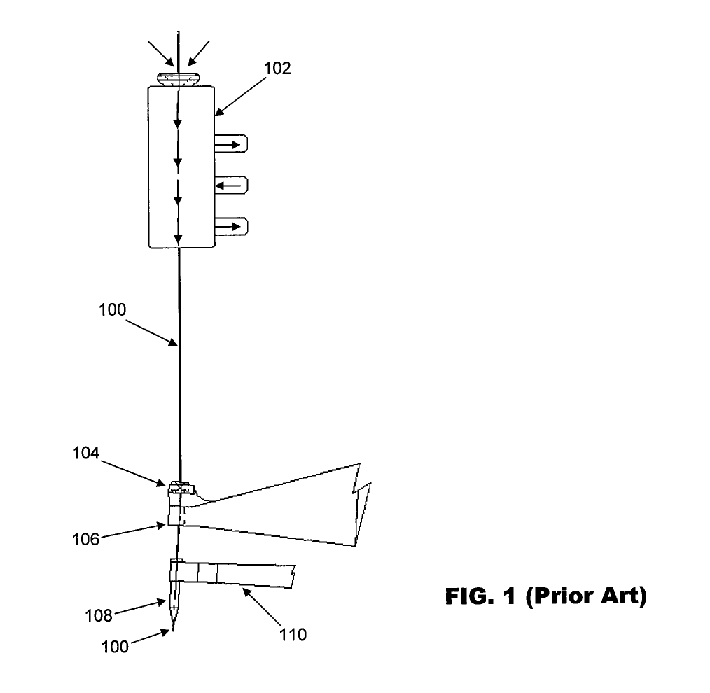

FIG. 2 is a side view of a conventional wire bonder including an upper wire clamp and a lower wire clamp illustrating the effects of undesirable disturbances in the air to a wire that is fed through the wire clamps;

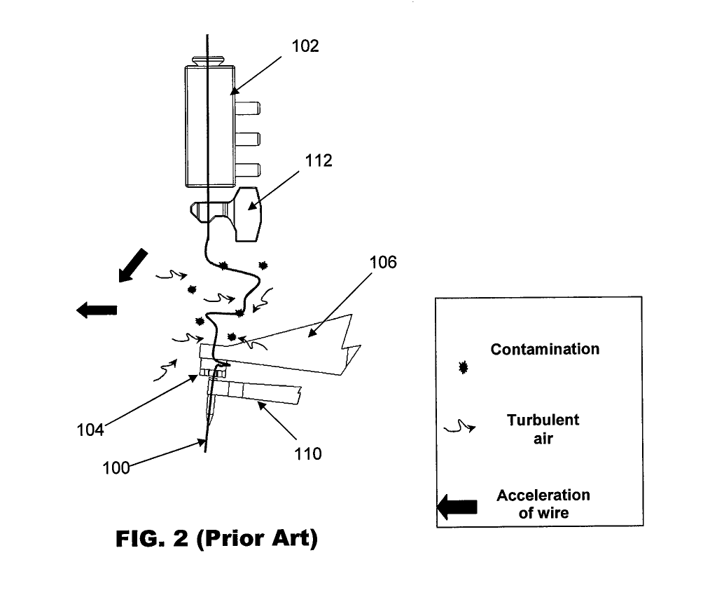

FIG. 3 is a side view of a conventional wire bonder showing a wire that has been fed into the wire bonder deviating from a vertical feeding path during wire bonding;

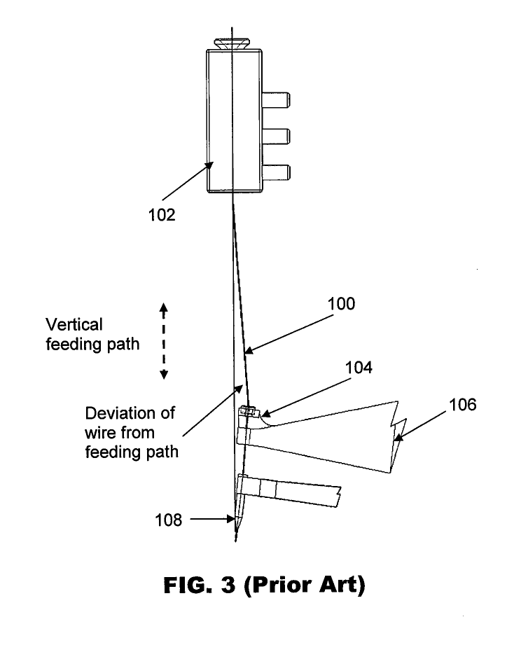

FIG. 4 is an isometric view of a wire bonder incorporating a wire feeding apparatus according to the preferred embodiment of the invention;

FIG. 5 is a side view of the wire bonder of FIG. 4 illustrating undesirable disturbances around a wire held in the wire bonder;

FIG. 6 is a side view of the wire bonder of FIG. 4 illustrating a wire that is aligned with the vertical feeding path during wire bonding; and

FIGS. 7A to 7C are side views of the pneumatic device for feeding a bonding wire into the wire bonder.

### DETAILED DESCRIPTION OF THE PREFERRED EMBODIMENT OF THE INVENTION

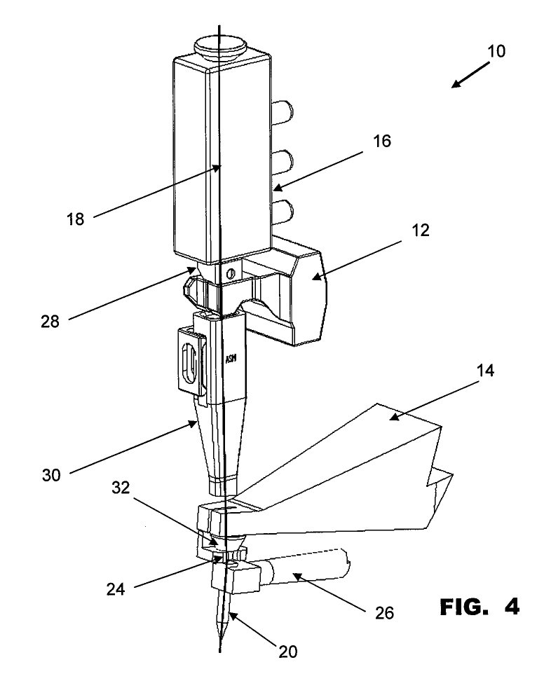

FIG. 4 is an isometric view of a wire bonder 10 incorporating a wire feeding apparatus according to the preferred embodiment of the invention. An upper wire clamp 12 and a lower wire clamp 14 are located along a wire feeding route of a length of bonding wire 18 to clamp the bonding wire 18 at their respective clamping points. A pneumatic device 16 is arranged along the wire feeding route and is located adjacent to and above the upper wire clamp 12. The bonding wire 18, such as gold or copper wire, is supplied from a wire source such as a wire spool (not shown) and fed into the pneumatic device 16. The pneumatic device 16 is operative to apply vertical forces to urge the bonding wire 18 to move upwards to apply tension on the bonding wire 18, or downwards to feed the bonding wire 18 through an outlet of the pneumatic device 16 towards a bonding tool or a capillary 20 for forming wire bonds. Bonding wire 18 protruding from a lower tip of the capillary 20 is used to perform wire bonding at the tip of the capillary 20.

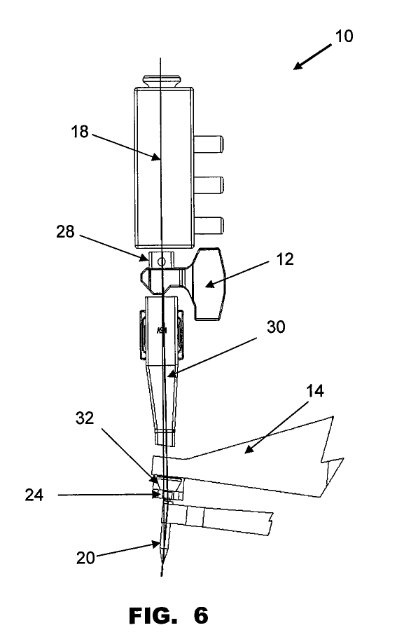

The lower wire clamp 14 is arranged with a wire guider 24 located over a transducer 26 such as an ultrasonic transducer along the wire feeding route. The wire guider 24 may be mounted onto a base of the lower wire clamp 14 and has a small hole for threading and guiding the bonding wire 18 through the hole along the wire feeding route to the capillary 20. This arrangement reduces a gap between the wire guider 24 and the capillary 20 such that the bonding wire 18 deviates less from a vertical feeding path (see FIG. 6). Improved wire looping and better wire bonds are possible with this arrangement.

The upper and lower wire clamps 12, 14 are operable to clamp onto the bonding wire 18 at their respective clamping points to restrain movement of the wire during wire bonding. When the pneumatic device 16 is activated, a downwards suction force is applied on the bonding wire 18 to urge and feed it past the clamping point of the lower wire clamp 14 towards the capillary 20.

Multiple chambers comprising a fixed upper wire guiding chamber 28, a fixed intermediate wire guiding chamber 30 and a fixed lower wire guiding chamber 32 are located respectively between the pneumatic device 16 and the upper wire clamp 12, the upper wire clamp 12 and the lower wire clamp 14 and the lower wire clamp 14 and the wire guider 24 respectively. The upper wire guiding chamber 28 extends substantially from the pneumatic device 16 to the upper wire clamp 12, the intermediate wire guiding chamber 30 extends substantially from the upper wire clamp 12 to the lower wire clamp 14 and the lower wire guiding chamber 32 extends substantially from the lower wire clamp 14 to the capillary 20.

These are wire guiding chambers which provide an enclosed wire feeding route for the bonding wire 18 which would otherwise be exposed to undesirable disturbances along the wire feeding route. That is, the bonding wire 18 is shielded and guided when it is fed from the pneumatic device 16 between the upper wire clamp 12, the lower wire clamp 14 and the capillary 20. As a result, the bonding wire 18 is isolated from the environment and has less exposure to turbulent air flow and contaminants that may be present at the bond head. The bonding wire 18 is also guided by the multiple chambers and does not bend or form kinks.

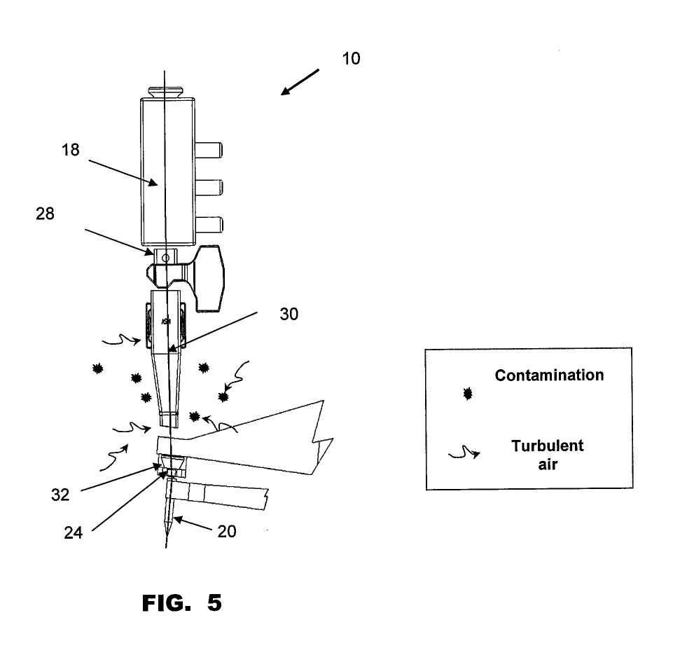

The benefit of using the wire guiding chambers 28, 30, 32 to isolate and guide the bonding wire 18 is shown in FIG. 5. FIG. 5 is a side view of the wire bonder 10 of the preferred embodiment of the invention illustrating undesirable disturbances around the bonding wire 18 held in the wire bonder 10. The wire guiding chambers, in particular the intermediate wire guiding chamber 30, are not only designed to guide the bonding wire 18 during wire feeding into the capillary 20 by longitudinally surrounding all side surfaces of the bonding wire along the wire feeding route. They also provide sufficient space that is enclosed by internal walls of the intermediate guiding chamber 30 to allow the wire to vibrate freely without hindrance due to manipulation of the bonding wire 18 arising from the wire bonding process. Therefore, the chambers do not need to be removed after guiding the wire feeding as they do not hinder the movement of the vibrating bonding wire 18 during wire bonding.

With the aforesaid isolation, guiding and automatic wire feeding, the requirement for machine stoppage is reduced by enhancing the ability of the machine to automatically recover from wire breakage during wire bonding. In this way, an operator of the wire bonder 10 does not have to interrupt the operation of the wire bonder 10, which significantly reduces machine idling time. The functions of the wire guiding chambers 28, 30, 32 to isolate and guide the bonding wire 18 assist wire feeding as well as increase throughput of the entire wire bonding process.

FIG. 6 is a side view of the present wire bonder 10 illustrating the wire 18 that is aligned with the vertical feeding path during wire bonding. The wire guiding chambers 28, 30, 32 restrict deviation of the bonding wire 18 therein and the arrangement of the wire guider 24 arranged right next to the capillary 20 further reduces the extent of any wire deviation. The intermediate wire guiding chamber 30 comprises a lower wall that tapers inwards towards the lower wire clamp 14 to become narrower next to the lower clamp 14 as compared to next to the upper wire clamp 12, so that wire feeding to the lower wire clamp 14 can be performed more accurately.

The wire bonder 10 incorporating the wire guiding chambers 28, 30, 32 and the arrangement of the wire guider 24 as described above substantially improves wire looping performance since bending of bonding wire 18 and formation of kinks are avoided and wire threading may be carried out more smoothly with less likelihood for error.

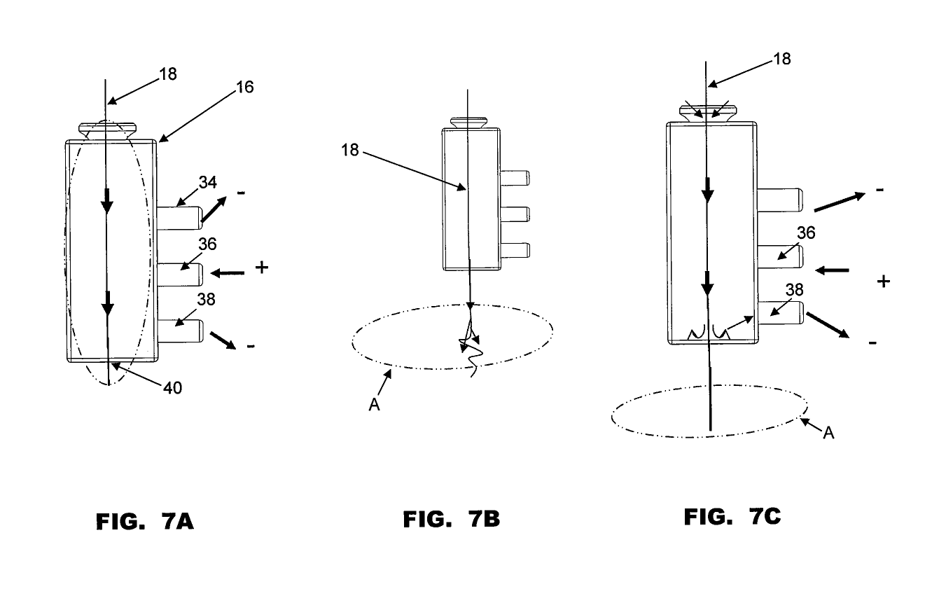

FIGS. 7A to 7C are side views of the pneumatic device 16 for feeding a bonding wire 18 into the wire bonder 10. FIG. 7A shows that the pneumatic device 16 may operate as a dual actuator by supplying a vacuum suction force through a top channel 34 and an input airflow into the pneumatic device 16 through a middle channel 36 which is a positive pressure generator to provide downward driving forces to the bonding wire 18. The downwards driving forces acting on the bonding wire 18 urge the bonding wire 18 downwards past the wire guider 24 towards the capillary 20. With proper application of this downwards force by the pneumatic device 16, the bonding wire 18 is fed through the hole of the wire guider 24 and the capillary 20 before protruding from the tip of the capillary 20. Thus, wire bonding may commence without any operator intervention to feed bonding wire to the capillary 20.

FIGS. 7B and 7C illustrate a means of reducing a fluctuation force acting on the bonding wire 18 emerging immediately below the pneumatic device 16 at a bottom outlet 40. When the exhaust airflow introduced via the middle channel 36 to serve to blow the bonding wire 18 downwards emerges from the pneumatic device 16 out of the outlet 40, it creates an interference in the air in a region A around the outlet 40 of the pneumatic device 16 as shown in FIG. 7B. This causes fluctuation to the bonding wire 18 in the region A, which adversely affects wire looping performance and wire bonding quality.

A bottom channel 38, which is a negative pressure generator, is located below the middle channel 36 and next to the outlet 40. A negative pressure generated at the bottom channel 38 helps divert part of the exhaust airflow away through the bottom channel 38 before the exhaust airflow emerges from the pneumatic device 16 such that any wire fluctuation is reduced as shown in FIG. 7C. Moreover, the intermediate wire guiding chamber 30 almost completely fills a gap between the upper wire clamp 12 and the lower wire clamp 14. Having the intermediate wire guiding chamber 30 located immediately adjacent to the upper wire clamp 12 also assists to contain the fluctuation of the wire with improved wire bonding and looping results. Similarly, the upper wire guiding chamber 28 almost completely fills a gap between the pneumatic device 16 and the upper wire clamp 12, and the lower wire guiding chamber 32 almost completely fills a gap between the lower wire clamp 14 and the capillary 20.

It should be appreciated that the wire feeding system incorporating the wire guiding chambers 28, 30, 32 according to the preferred embodiment of the invention speeds up wire threading and gives rise to improved wire looping performance during wire bonding. This is possible as the wire guiding chambers 28, 30, 32 provide support to smoothen the acceleration experienced by the wire during wire bonding. The wire guiding chambers 28, 30, 32 are also configured to isolate and shield the wire from air turbulence and contaminants in the bonding area as well as to guide the wire during feeding into the capillary 20. The interior space provided within the wire guiding chambers 28, 30, 32 is further sufficient to permit wire bonding without having to first move these multiple chambers away from the wire after feeding wire into the capillary 20. Therefore, wire bonding process can be speeded up and better wire looping and wire bonds can be formed.

The invention described herein is susceptible to variations, modifications and/or additions other than those specifically described and it is to be understood that the invention includes all such variations, modifications and/or additions which fall within the spirit and scope of the above description.

1. A wire bonder comprising:
a bonding tool for forming wire bonds;
a pneumatic device for feeding wire to the bonding tool;
an upper clamp and a lower clamp aligned along a wire feeding route between the pneumatic device and the bonding tool and configured to clamp the wire, respectively, at upper and lower clamping points; and
a fixed intermediate guiding chamber extending from the upper clamp to the lower clamp, wherein the fixed intermediate guiding chamber comprises:
internal walls positioned and configured to guide the wire along the wire feeding route and to shield the wire from exposure to air turbulence and contaminants during wire bonding, and
a tapering section that tapers inwardly such that a first end of the fixed intermediate guiding chamber adjacent the upper clamp has a greater width than a second end of the fixed intermediate guiding chamber adjacent the lower clamp.

2. The wire bonder as claimed in claim 1, wherein the intermediate wire guiding chamber is positioned directly adjacent to upper clamp.

3. The wire bonder as claimed in claim 1, further comprising a fixed upper wire guiding chamber extending from the pneumatic device to the upper clamp, the fixed upper wire guiding chamber positioned and configured to enclose the wire along the wire feeding route and which is operative to shield and guide the wire.

4. The wire bonder as claimed in claim 3, wherein the upper wire guiding chamber is positioned directly between the pneumatic device and the upper clamp.

5. The wire bonder as claimed in claim 1, further comprising a fixed lower wire guiding chamber extending from the lower clamp to the bonding tool, the fixed lower wire guiding chamber positioned and configured to enclose the wire along the wire feeding route and to shield and to guide the wire.

6. The wire bonder as claimed in claim 5, wherein the lower wire guiding chamber is positioned between the lower clamp and the bonding tool.

7. The wire bonder as claimed in claim 5, further comprising a wire guider located between the lower wire guiding chamber and the bonding tool, the wire guider further comprising a hole for threading and guiding the wire through the hole.

8. The wire bonder as claimed in claim 1, wherein the intermediate wire guiding chamber longitudinally surrounds all side surfaces of the wire along the wire feeding route.

9. The wire bonder as claimed in claim 1, wherein the intermediate wire guiding chamber includes sufficient space enclosed by the internal walls of the intermediate wire guiding chamber to allow the wire to vibrate freely without hindrance during the wire bonding process.

10. The wire bonder as claimed in claim 1, wherein the intermediate wire guiding chamber comprises a lower wall that tapers towards the lower clamp to become narrower next to the lower clamp as compared to next to the upper clamp.

11. The wire bonder as claimed in claim 1, wherein the pneumatic device further comprises:
a bottom outlet positioned and configured to allow the wire to pass out of the pneumatic device;
a positive pressure channel positioned and configured to introduce an airflow into the pneumatic device for blowing the wire out of the outlet; and
a negative pressure channel below the positive pressure channel and located next to the outlet, the negative pressure channel configured to collect and exhaust some of the airflow introduced by the positive pressure channel from the pneumatic device before the airflow exits from the outlet.
